(19) United States
(12) Patent Application Publication
(10) Pub. No.: US 2010/0053106 A1
(43) Pub. Date: Mar. 4, 2010

(54) SENSING CIRCUIT FOR TOUCH PANEL

(76) Inventors: Wen-Chun Wang, Taichung City (TW); Chien-Ting Chan, Chang Hua County (TW); Wen-Tui Liao, Tai Chung City (TW)

Correspondence Address: Muncy, Geissler, Olds & Lowe, PLLC, P.O. BOX 1364, FAIRFAX, VA, 22038-1364, US

(21) Appl. No.: 12/548,890

(22) Filed: Aug. 27, 2009

(30) Foreign Application Priority Data
Aug. 28, 2008 (TW) 097132857

(51) Int. Cl. G06F 3/041

(52) U.S. Cl. 345/173

(57) ABSTRACT

A sensing circuit for a touch panel is disclosed. The sensing circuit includes a switching device, a passive device and a sensing device. The switching device receives an input signal and outputs the input signal according to a control signal. The passive device couples to the switching device. The sensing device couples to the switching device to form a node, receives the input signal to generate a reference voltage on the node, and changes the value of the reference voltage to generate a target voltage according to a touching pressure on a preset position on the touch panel from a user.

### BACKGROUND OF THE INVENTION

(a) Field of the Invention

The invention relates to a sensing circuit, particularly to a sensing circuit for a touch panel.

(b) Description of the Related Art

In general, a touch panel circuit 10 is shown in FIG. 1. A bias control terminal “Bias” provides the on state of a transistor for a voltage control circuit to charge each capacitor. When a user touches the panel, the voltage value(s) for some capacitor(s) in the circuit is changed. Then, the scan lines “Select” are used to read the current variation of any of each pixel on the panel and the current is converted into voltage via the control of a chip (IC). Thus, the operation of a touch panel is complete.

It should be noted that the circuit in the prior art uses not only scan lines “Select” to drive transistors but also needs an additional set of bias control terminal “Bias” to provide voltage. Thus, it results in the complication of the circuit driving design for a touch panel as well as the circuit layout. Consequently, production cost is increased.

### BRIEF SUMMARY OF THE INVENTION

In light of the above-mentioned problems, one object of the invention is to provide a touch panel and a sensing circuit applicable to a touch panel.

One object of the invention is to reduce the complexity of the sensing circuit layout for a touch panel.

One object of the invention is to reduce the area of the sensing circuit layout for a touch panel.

One object of the invention is to reduce the production cost of the sensing circuit layout for a touch panel.

One embodiment of the invention provides a touch panel. The sensing circuit includes a switching device, a first capacitor, and a sensing device. The on or off state of the switching device is controlled by at least a signal. The first capacitor couples to two terminals of the switching device. The sensing device couples to one terminal of the switching device to form a node. When the switching device is on, a reference voltage is generated on the node. The sensing device changes the reference voltage to generate a target voltage according to whether at least a preset position on the touch panel is touched or not, or the extent of touching the preset position.

Furthermore, another embodiment of the invention provides a sensing circuit for a touch panel. The sensing circuit includes a switching device, a passive device, and a sensing device. The switching device receives an input signal and outputs the input signal according to a control signal. The passive device couples to the switching device. The sensing device couples to the switching device to form a node, receives the input signal to generate a reference voltage on the node, and changes the value of the reference voltage to generate a target voltage according to a touching pressure on at least a preset position on the touch panel from at least a user.

Moreover, another embodiment of the invention provides a sensing circuit for a touch panel, corresponding to a pixel or pixels of a panel where each and every of the pixel is corresponding to a preset position of the surface of the panel. The sensing circuit includes a switching device, a first capacitor, and a second capacitor. The switching device comprises at least one control terminal, at least one input terminal, and at least one output terminal. The switching device receives an input signal from the input terminal and receives a control signal from the control terminal. The status of the switching device is determined by the control signal. The first capacitor has one terminal coupling to the output terminal of the switching device and the other terminal coupling to the input terminal of the switching device. The second capacitor has one terminal coupling to the output terminal of the switching device to form a node and the other terminal coupling to a common point (VCOM). A reference voltage is generated on the node when the switching device is turned on. The second capacitor changes the reference voltage to generate a target voltage according to whether the preset position is touched or not, or the extent of touching the preset position.

The touch panel and the sensing circuit thereof according to the invention can utilize the sensing device (or the second capacitor) to sense the position of the panel being touched (or pressed) and also use at least one signal to reset the sensing device. Compared to the prior art, the touch panel and the sensing circuit thereof according to the invention only needs one additional passive device to achieve both of the sense and reset functions. Thus, the circuit layout thereof can be simplified and the complexity and area of the circuit allocation can be reduced. Therefore, the production cost can be reduced.

### BRIEF DESCRIPTION OF THE DRAWINGS

FIG. 1 shows a schematic diagram illustrating the touch panel circuit in the prior art.

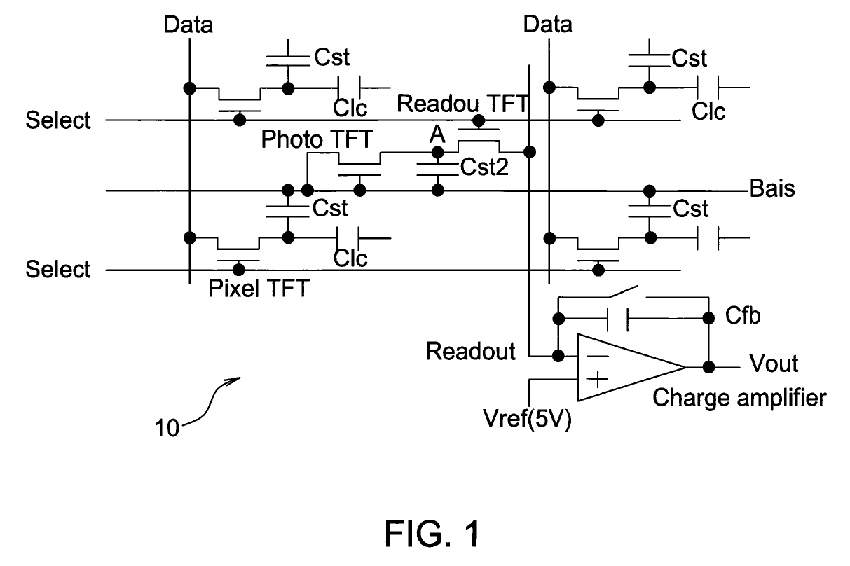

FIG. 2 shows a schematic diagram illustrating a display device.

FIG. 3 shows a schematic diagram illustrating a sensing circuit for a touch panel according to one embodiment of the invention.

FIG. 4 shows a schematic diagram illustrating a sensing circuit for a touch panel according to another embodiment of the invention.

### DETAILED DESCRIPTION OF THE INVENTION

The touch panel and the sensing circuit thereof according to the invention are described in details with reference to the drawings.

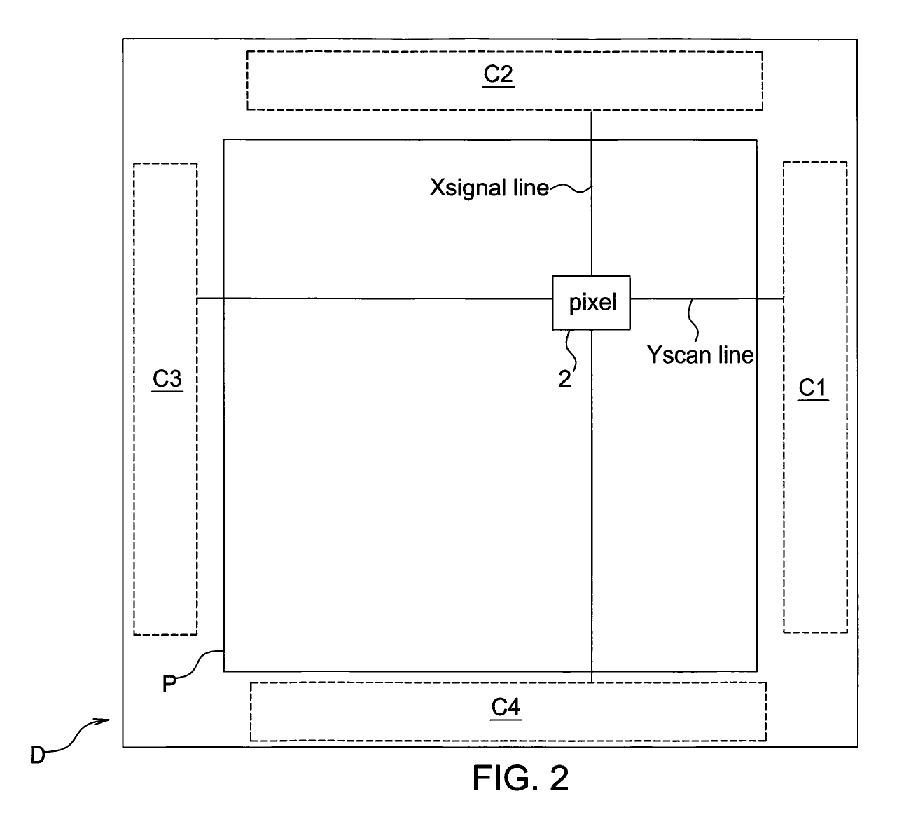

FIG. 2 shows a schematic diagram illustrating a display device D. As shown in FIG. 2, the display device D includes at least one pixel region P and a plurality of circuit blocks C1˜C4 disposed on the sides of the pixel region P. In the pixel region P, a plurality of scan lines Y and a plurality of signal lines X are disposed. The scan lines Y and the signal lines X intersect to each other and a pixel 2 is disposed on each intersecting position.

The number of the circuit blocks C1˜C4 is not limited to the above example and can be adjusted according to the requirement. For clarity, only one pixel is drawn to show the relation among the pixel 2, the scan line Y and the signal line X. In fact, the number of the pixel(s) 2 corresponds to the resolution of a panel. One or a plurality of the pixels 2 correspond to the sensing circuit according to one embodiment of the invention. Certainly, the number of pixels (resolution of a panel) corresponding to the sensing circuit is adjusted according to the design. The operation of the pixel region P and the circuit blocks C1˜C4 should be well known to those who are skilled in the art and will not be described in great detail.

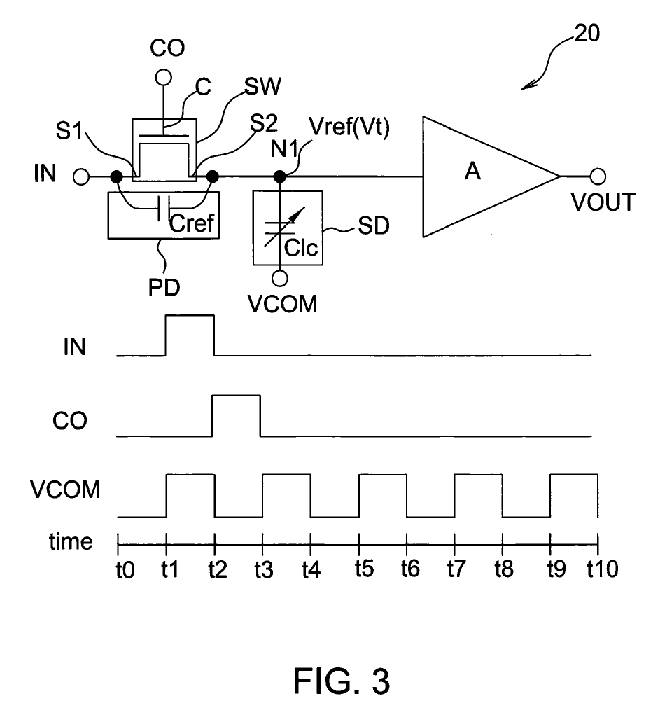

FIG. 3 shows a schematic diagram illustrating a sensing circuit for a touch panel according to one embodiment of the invention. The sensing circuit 20 can be applied in the display D having a touch panel and is provided corresponding to one or a plurality of the pixels 2. Each and every pixel 2 corresponds to a preset position of the surface of the panel. Besides, when a user touches or presses the panel, a physical quantity is generated on the position of at least one pixel 2 and then is used by the sensing circuit 20 to generate a corresponding electrical signal for the pixel.

The sensing circuit 20 includes a switching device SW, a passive device PD, a sensing device SD, and a calculator A.

The switching device SW receives an input signal IN and determinates how to output the input signal IN according to a control signal CO. In one embodiment, the switching device SW is a thin film transistor (TFT) and comprises at least one control terminal C, at least one input terminal S1, and at least one output terminal S2. The input terminal S1 of the switching device SW receives the input signal IN. The control terminal C determines the state (either ON or OFF) of the switching device SW according to the control signal CO so that the switching device SW can determinate how to output the input signal IN. Certainly, in another embodiment, the switching device SW can be any other current semiconductor device having switching functionality or any semiconductor device having switching functionality to be developed in the future.

The passive device PD couples to the switching device SW. In one embodiment, the passive device PD can be a capacitor and has one terminal coupling to the output terminal S2 of the switching device SW and the other terminal coupling to the input terminal S1. In another embodiment, the passive device PD can be any other current passive device or any passive device to be developed in the future.

The sensing device SD is used to sense the physical quantity generated by touching or pressing any position of the panel and convert this physical quantity into an electrical signal. In one embodiment, the sensing device SD is a variable capacitor while in another embodiment the sensing device SD is any current or future device that can sense the touching phenomenon.

In one embodiment, one terminal of the sensing device SD couples to the output terminal S2 of the switching device SW to form a node N1 and the other terminal couples to the common point (VCOM). During operation, the sensing device SD receives the input signal IN and generates a reference voltage Vref on the node N1. When a user touches one position of the surface of the panel and the position corresponds to one pixel of the pixel region P shown in FIG. 2, the sensing device SW of the sensing circuit 20 corresponding to this pixel changes the value of the reference voltage Vref to generate a target voltage Vt according to the extent (touching pressuring) of the touching position from a user. For example, as the sensing device SD is a variable capacitor, according to whether a user touches the pixel position corresponding to the sensing device SD or not, the extent of touching the pixel position, or the touching pressure, the sensing device SD changes the cell gap of the variable capacitor to generate the corresponding capacitance change to thereby change the reference voltage Vref in respond to this change accordingly.

The calculator A is used to process and convert the target voltage Vt to thereby generate an output voltage VOUT. In one embodiment, the calculator A is an operational amplifier (OPA). The calculator A converts the reference voltage Vref into the voltage Vt according to the change of the voltage level of the node N1 and outputs the output voltage VOUT after amplifying the voltage Vt.

Please refer to the oscillogram shown in the lower part of FIG. 3. At the time t1˜t2, the control signal CO is at low voltage level 0 and the common point VCOM is at high voltage level 1, the control terminal C turns the switching device SW OFF according to the control signal CO and thus the input signal IN at high voltage level 1 couples to the node N1 via the passive device PD. The voltage value of the input signal IN is divided on the passive device and the sensing device SD and a first reference voltage Vref on the node N1 is generated. At this time, a target voltage Vt is generated from the reference voltage Vref according to whether a user touches or not, or the extent of touching a pixel position of the surface of the panel. Then, the calculator A processes and converts the changed target voltage Vt to generate the output voltage VOUT.

At the time t2˜t3, when the control signal CO is at high voltage level 1 and the common point VCOM is at low voltage level 0, the control terminal C turns the switching device SW ON according to the control signal CO. Thus, the input signal IN makes the node N1 store low voltage level 0 of the input signal IN so as to reset the voltage value of the node N1.

By the above operation, the touch panel and the sensing circuit 20 thereof according to the invention can use the sensing device to sense the physical quantity generated by touching or pressing one position of the surface of the panel to change the voltage value of the node N1 for sensing any position on the panel touched by a user. In addition, the control signal CO and the input signal IN together are used to reset the voltage value of the node N1. Thus, the operation of a touch panel is complete. Compared to the prior art, the sensing circuit 20 according to the invention only needs one additional passive device to achieve both of the sense and reset functions. Thus, the circuit layout thereof can be simplified and the complexity and area of the circuit allocation can be reduced. Therefore, the production cost can be reduced.

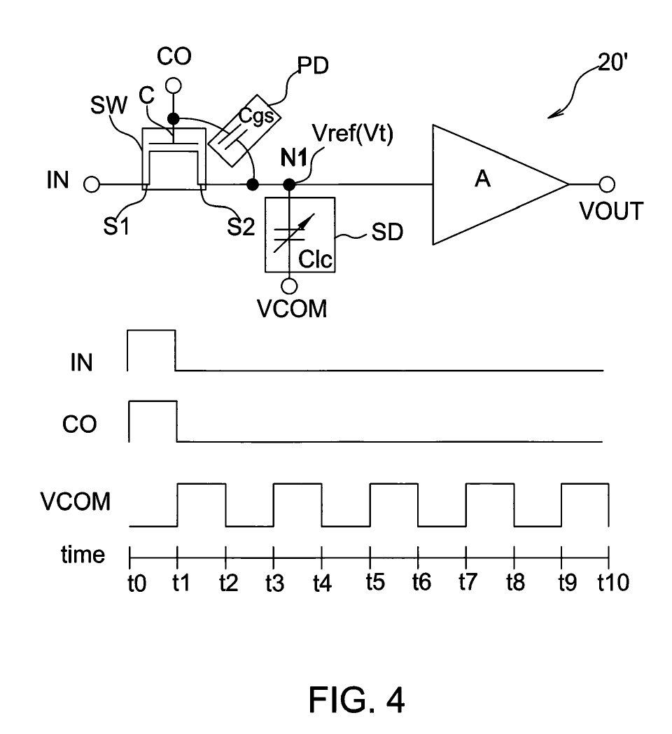

Furthermore, as shown in FIG. 4, the sensing circuit 20′ according to another embodiment of the invention can utilize the feed-through effect. It is similar to those in the switching device SW. A capacitor Cgs couples between the gate electrode (control terminal C) and the source electrode (output terminal S2) of the thin film transistor to achieve the effect of generating a reference voltage Vref on the node N1. It should be noted that the principle of the feed-through effect should be understood by those who are skilled in the art. Thus, the further detail will not be described hereafter.

The operational method of the sensing circuit 20′ shown in FIG. 4 will be described in the following.

At the time t0˜t1, the input signal IN is at high voltage level 1, the common point VCOM is at low voltage level 0, and the switching device SW is turned on according to the control signal CO of the high voltage level 1 to output the input signal IN to the node N1.

At the time t1˜t2, the input signal IN is at low voltage level 0, the common point VCOM is at high voltage level 1, and the switching device SW is turned off according to the control signal CO of the low voltage level 0. A reference voltage Vref is generated on the node N1 due to feed-through effect. The equation for the reference voltage Vref is as follows:

Vref=VIN−(VGH−VGL)*(Cgs/(Clc+Cgs)) (1)

where VIN represents the voltage of the input signal IN; VGH represents the voltage of the control signal CO at high voltage level 1; and VGL represents the voltage of the control signal CO at low voltage level 0. When the switching device SW is off, the feed-through effect occurs. The magnitude of the feed-through effect depends on the capacitance of Cgs and Clc. Clc indicates the liquid crystal capacitance of the sensing device SD while Cgs indicates the parasitic capacitance of the switching device SW.

When a user touches one position of the panel surface and the position corresponds to a pixel position of the pixel region P shown in FIG. 2, the sensing device SD of the sensing circuit 20′ of the pixel position changes the value of the reference voltage Vref according to the extent (touching pressure) of touching the position from the user. Thus, the value of the reference voltage Vref is changed due to the change of the sensing device SD (such as the capacitance Clc) to generate a corresponding voltage Vt. By the change of Vref and Vt, an output signal VOUT is converted by the calculator A to make the integrated circuit (IC) of the panel seize the voltage change on the node to recognize the position touched by the user. In addition, simplifying the layout and lowering the production cost can also be accomplished.

It should be noted that the input signal IN and the control signal CO have a preset relation between the voltage levels thereof. In one embodiment, the voltage levels of the input signal IN and the control signal CO are set according to the successive relation of the scan lines of the panel. For example, when the input signal IN is the n^{th} (n is an integer and smaller than infinity) scan line signal G(n), the control signal CO is the n+1^{th} scan line signal G(n+1) or the n−1^{th} scan line signal G(n−1). In another embodiment, the input signal IN and the control signal CO are synchronized. For example, the input signal IN and the control signal CO are the same scan line signal G(n). In addition, one or both of the input signal IN and the control signal CO are scan line signals. Or, one or both of the input signal IN and the control signal CO are generated by an external device. Certainly, either the input signal IN or the control signal CO can be generated by an external device and the other one uses the scan line signal of the panel.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A sensing circuit for a touch panel, comprising:
a switching device for receiving an input signal and outputting the input signal according to a control signal;
a passive device coupling to the switching device; and
a sensing device coupling to the switching device to form a node for receiving the input signal to generate a reference voltage on the node and to change the value of the reference voltage to generate a target voltage according to a touching pressure on at least a preset position on the touch panel from at least a user.

2. The circuit according to claim 1, further comprising: a calculator for receiving and converting the target voltage to generate an output voltage.

3. The circuit according to claim 1, wherein the switching device comprises at least one control terminal, at least one input terminal, and at least one output terminal and the passive device has one terminal coupling to the output terminal of the switching device and the other terminal coupling to the input or control terminal of the switching device.

4. The circuit according to claim 1, wherein the voltage level of the input signal and the voltage level of the control signal have a preset relation.

5. The circuit according to claim 1, wherein one or both of the input signal and the control signal are scan line signals.

6. The circuit according to claim 1, wherein one or both of the input signal and the control signal are generated by an external device.

7. The circuit according to claim 1, wherein the switching device is a semiconductor device or thin film transistor

8. The circuit according to claim 1, wherein the passive device is a capacitor or a capacitor formed by feed-through effect.

9. A sensing circuit for a touch panel, comprising:
a switching device comprising at least one control terminal, at least one input terminal, and at least one output terminal wherein the input terminal receives an input signal, the control terminal receives a control signal, and the status of the switching device is determined by the control signal;
a first capacitor having one terminal coupling to the output terminal of the switching device and the other terminal coupling to the input terminal of the switching device; and
a second capacitor having one terminal coupling to the output terminal of the switching device to form a node and the other terminal coupling to a common point (VCOM);
wherein a reference voltage is generated on the node when the switching device is turned on and the second capacitor changes the reference voltage to generate a target voltage according to whether at least a preset position on the touch panel is touched or not, or the extent of touching the preset position.

10. The circuit according to claim 9, wherein a preset voltage is generated on the node when the switching device is turned off, in order to achieve a reset function.

11. The circuit according to claim 9, further comprising: a calculator for processing and converting the target voltage to generate an output voltage.

12. The circuit according to claim 9, wherein the voltage level of the input signal and the voltage level of the control signal have a preset relation.

13. The circuit according to claim 9, wherein the input signal and the control signal are synchronized scan line signals or successive scan line signals.

14. The circuit according to claim 9, wherein one or both of the input signal and the control signal are scan line signals.

15. The circuit according to claim 9, wherein one or both of the input signal and the control signal are generated by an external device.

16. The circuit according to claim 9, wherein the switching device is a semiconductor device or thin film transistor and the second capacitor is a variable capacitor.

17. A touch panel, comprising: a plurality of pixels wherein each and every pixel corresponds to a preset position of the surface of the panel, one or a plurality of the pixels correspond to a sensing circuit, and the sensing circuit comprises:
a switching device, the on or off state of which is controlled by at least a signal;
a first capacitor coupling to two terminals of the switching device; and
a sensing device coupling to one terminal of the switching device to form a node wherein a reference voltage is generated one the node when the switching device is on and the sensing device changes the reference voltage to generate a target voltage according to whether the preset position is touched or not, or the extent of touching the preset position.

18. The touch panel according to claim 17, further comprising: a plurality of circuit blocks to cooperate with the operation of the pixels.

19. The touch panel according to claim 17, wherein the sensing circuit further comprises a calculator for processing and converting the target voltage to generate an output voltage.

20. The touch panel according to claim 17, wherein the switching device is a semiconductor device or thin film transistor, and the sensing device is a variable capacitor, and the first capacitor is formed by feed-through effect.
